(19) United States
(12) Patent Application Publication
(10) Pub. No.: US 2020/0273326 A1
(43) Pub. Date: Aug. 27, 2020

(54) VEHICLE TRAFFIC MONITORING APPARATUS

(71) Applicant: THE CROWN IN RIGHT OF THE STATE OF SOUTH AUSTRALIA, Adelaide (AU)

(72) Inventors: Mark Shotton, Adelaide (AU); James Cox, Adelaide (AU)

(21) Appl. No.: 15/733,042

(22) PCT Filed: Oct. 29, 2018
(86) PCT No.: PCT/AU2018/000209

§ 371 Date: Apr. 27, 2020

(30) Foreign Application Priority Data
Oct. 27, 2017 (AU) 2017904365

(51) Int. Cl. G08G 1/01; H04W 4/44; H04W 24/08

(52) U.S. Cl. CPC G08G 1/012; G08G 1/0133; H04W 24/08; H04W 4/44; G08G 1/0145

(57) ABSTRACT

A traffic management system uses a network of traffic detecting apparatus distributed through the traffic network, such as at each traffic light and detects Bluetooth transmissions from devices in passing vehicles, and sends capture messages back to a traffic network monitoring centre. The traffic network monitoring centre estimates travel times, excess delays and congestion. To increase capture data rates the traffic detecting apparatus are configured to detect the lower address part (LAP) of Bluetooth Device Address in received transmissions. The apparatus may also detect Wi-Fi device MAC addresses to further increase the capture rate.

### PRIORITY DOCUMENTS

The present application claims priority from Australian Provisional Patent Application No. 2017904365 titled “Vehicle Traffic Monitoring Apparatus” and filed on 27 Oct. 2017, the content of which is hereby incorporated by reference in its entirety.

### TECHNICAL FIELD

The present disclosure relates to traffic management systems. In a particular form the present disclosure relates to vehicle traffic monitoring apparatus used in traffic management systems for use in arterial road networks.

### BACKGROUND

In most cities the number of vehicles travelling through road transport networks has continued to grow, leading to increased congestion. In an attempt to manage the increased traffic, a range of traffic management systems have been developed. The first systems, such as the Sydney Coordinated Adaptive Traffic System (SCATS) operated at the level of an intersection and used loop sensors in the road to detect vehicles approaching an intersection. This data was used to make an estimate of the state of the intersection (or incoming traffic flows) and a controller attempted to optimise the light sequence to optimise traffic flow and delays. More recently SCATS and similar systems have been extended by linking adjacent intersections to increase traffic flow through a local region of the network or to include additional sensors such Bluetooth receivers to detect as fixed camera systems to detect and monitor traffic flows.

Numerous systems have been developed for freeways that can monitor speeds and detect incidents. However freeways are characterised by long road segments with few (or no) intersections and free-flowing traffic and so are not easily transferrable to normal arterial road networks found throughout cities. Further such freeway systems are often expensive and so the expenditure can only be warranted for critical segments of road infrastructure. As such, the monitoring of arterial road networks has generally been limited to the installation of CCTV cameras or via the congestion monitors such as loop sensors used in SCATS, and this information is fed back to a traffic monitoring centre.

Recently a prototype Bluetooth based travel time system was deployed integrated Bluetooth transceiver apparatus into SCATS boxes at intersections and configured to discover the 48 bit MAC addresses of nearby classic Bluetooth devices, such as headsets or car audio systems in vehicles passing through the intersection that are in discovery mode. Whilst mobile phones can potentially be discovered, they are typically only in a discovery mode during a pairing process (ie when a user has actively gone to a settings page to pair with another device), and so in most cases are not discoverable in vehicles passing through an intersection. The system uses a discovery period of about 15 seconds, and once a 48 bit MAC address was found, this was time stamped, and a message comprising the MAC address, time, and site ID was sent back to the traffic monitoring centre using the SCATS network link. This data was then used for planning and real time analysis of traffic flows to allow operators at the traffic monitoring centre to monitor congestion and adjust intersections to improve traffic flow through the network. Whilst this system has provided proof of concept, the Bluetooth receivers are only able to capture about 15% of the entire vehicle traffic passing through an intersection. Further the detectors are typically located at one corner of an intersection which can limit detection over the entire intersection. In particular the lack of data limited estimation of origin-destination travel times. This thus limits the reliability and usefulness of the system.

One potential way to try and increase data rates would be to listen for smartphones looking for Wi-Fi access points, as there are a typically a much large number of smartphones passing through an intersection compared to devices in Bluetooth discovery mode. Wi-Fi devices are configured to scan for an access point by transmitting a probe request frame containing the Wi-Fi MAC address of the transmitting device. Typically a device sends a probe request on a channel, briefly (eg 100 ms) listen for a probe response, and then moves to another channel and repeats the process of the 13 Wi-Fi channels. However whilst the amount of traffic is potentially much larger, one significant problem with smartphones is that the phone is able to decide when it will check for a new Wi-Fi access point, and in order to conserve battery life, most smartphones search for an access point once every 60 seconds. That is a set of probe request frames are only transmitted once per minute, for around a second, and so the device will only be discoverable using Wi-Fi if it is within range for 60 seconds or more. Thus in a signalised road environment where there is relatively free flowing traffic, many devices will not be discoverable whilst they are in range of a detector. As such the effective Wi-Fi detection rates are about the same as Bluetooth discovery rates. Further, whilst a device may be detected at one intersection, given the long (60 second) undiscoverable period, the device may not be detected at the next intersection leading to a pairing rate (ie detection of the same device at two intersections) that is much lower than that for discoverable Bluetooth devices. Further, when in sleep mode, some devices (eg some apple iPhones), do not use their hardware MAC address to find access points, and instead use a random, often one-off, software generated MAC address. This prevents pairing of records between sites. Another problem is that Wi-Fi will detect smartphones on pedestrians, bikes and in buses, so in a busy city location these sources can generate significant additional noise. There is thus a need to provide improved vehicle monitoring devices, or at a useful alternative to present systems.

### SUMMARY

According to a first aspect, there is provided a traffic monitoring Bluetooth transceiver apparatus comprising:

at least one antenna;

an RF transceiver module configured to operate in a least the 2.4 GHz Band;

at least one microprocessor configured to implement a Bluetooth Stack and to detect at least the Lower Address Part (LAP) of a Bluetooth Device Address in a received transmission; and

a network interface configured to send a plurality of capture messages, each capture message comprising a representation of a received LAP, a time stamp, and a device site identifier (ID).

In a further form the at least one microprocessor is configured to monitor further transmissions for transmissions including the received LAP, and when no transmissions including the received LAP have been received within a predetermined time out window, the capture message is sent. In a further form the at least one microprocessor is further configured to detect a Wi-Fi probe request, and extract a Wi-Fi device MAC address from the probe request, and the network interface is configured to send a capture message comprising the received Wi-Fi device MAC, a time stamp and the device site ID.

According to a second aspect, there is provided a traffic monitoring system comprising:

a plurality of traffic monitoring Bluetooth transceiver apparatus each comprising:
at least one antenna;
an RF transceiver module configured to operate in a least the 2.4 GHz Band;
a microprocessor configured to implement a Bluetooth Stack and to detect at least the Lower Address Part (LAP) of a Bluetooth Device Address in a received transmission; and
a network interface configured to send a plurality of capture messages, each capture message comprising a representation of a received LAP, a time stamp, and a device site identifier (ID); and

a traffic network monitoring centre, wherein

each traffic monitoring Bluetooth transceiver apparatus is located at a fixed site location in a traffic network and the device site ID is associated with the site location;

the traffic network monitoring centre is configured to receive and process the capture messages to determine link travel times for a link defined by two traffic monitoring Bluetooth transceiver apparatus, and obtain an estimate of an excess delay and a congestion for each link.

In a further form the at least one microprocessor is further configured to detect a Wi-Fi probe request, and extract a Wi-Fi device MAC address from the probe request, and the network interface is configured to send a capture message comprising the received Wi-Fi device MAC, a time stamp and the device site ID.

According to a third aspect, there is provided a method for monitoring traffic comprising:

receiving, by a receiver located at a fixed site location in a road traffic network, one or more radio frequency transmissions;

detecting at least the Lower Address Part (LAP) of a Bluetooth Device Address in one or more received transmissions;

transmitting a capture message comprising a representation of a received LAP, a time stamp, and a device site identifier (ID) of the receiver to a monitoring centre;

receiving a plurality of capture messages from a plurality of receivers at a plurality of fixed site locations and identifying a LAP received at two of the plurality of fixed site locations to determine a link travel time for a link defined by the two fixed site locations, and obtaining an estimate of an excess delay and a congestion for each link.

In a further form the detecting step further comprises:

detecting at least the Lower Address Part (LAP) of a Bluetooth Device Address in a received transmission;

monitoring further transmissions for transmissions including the received LAP, and when no further transmissions including the received LAP have been received within a predetermined time out window, transmitting the capture message comprising a representation of the received LAP.

In a further form the detecting step further comprises:

detecting a Wi-Fi probe request,

extracting a Wi-Fi device MAC address from the probe request; and

transmitting a capture message comprising a representation of a received Wi-Fi device MAC address, a time stamp, and a device site identifier (ID) of the receiver to a monitoring centre.

### BRIEF DESCRIPTION OF DRAWINGS

Embodiments of the present disclosure will be discussed with reference to the accompanying drawings wherein:

FIG. 1A is a schematic drawing of a traffic monitoring system according to an embodiment;

FIG. 1B is a map of a road traffic network according to an according to an embodiment;

FIG. 1C is map of a portion of a road traffic network indicating the locations and site IDs of traffic monitoring Bluetooth transceiver apparatus, and road links showing excess congestion according to an embodiment;

FIG. 1D is schematic drawing of a traffic monitoring system according to another embodiment;

FIG. 2A is a representation of a Bluetooth MAC address format;

FIG. 2B is a representation of a frame of a Bluetooth message between paired devices;

FIG. 2C is a schematic diagram of a two paired Bluetooth devices sharing a message which is intercepted by a traffic monitoring Bluetooth transceiver apparatus to capture the LAP in the message according to an embodiment;

FIG. 3 is a schematic representation of a traffic monitoring Bluetooth transceiver according to an embodiment;

FIG. 4A is a plot of the number of unique Bluetooth devices discovers as a function of time spanning the point in time when LAP packet detection is switched on according to an embodiment;

FIG. 4B is a plot of histograms of the pairing count rate for a first direction of travel between two devices before and after turning on LAP packet detection according to an embodiment;

FIG. 4C is a plot of histograms of the pairing count rate for a second direction of travel between two devices before and after turning on LAP packet detection according to an embodiment;

FIG. 5 is a plot of the raw device counts for a device configured to detect classic Bluetooth discovery packets, LAP in Bluetooth packets and Wi-Fi probe requests packets according to an embodiment; and

FIG. 6 is a schematic diagram of a modified iBeacon message frame according to an embodiment.

In the following description, like reference characters designate like or corresponding parts throughout the figures.

### DESCRIPTION OF EMBODIMENTS

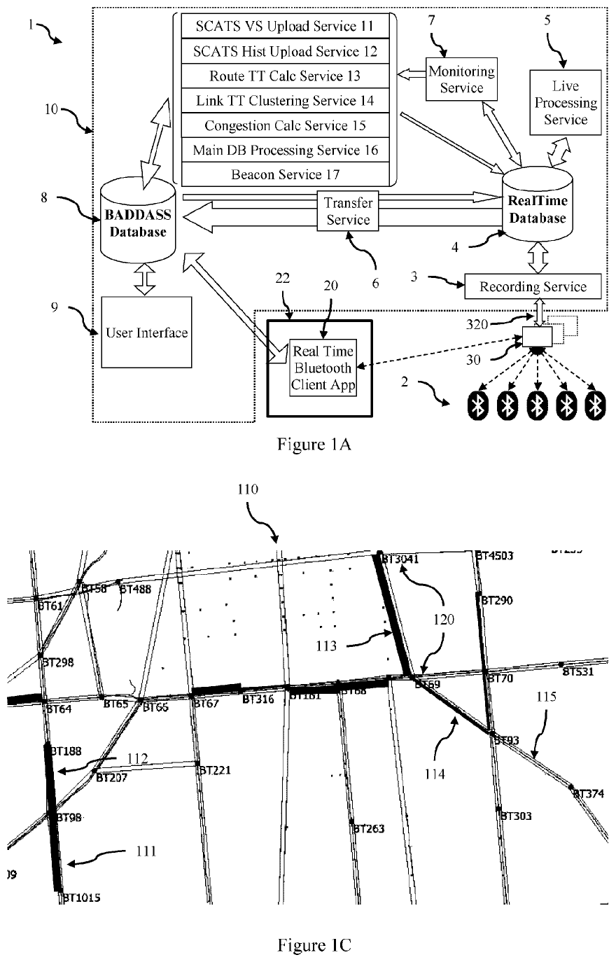

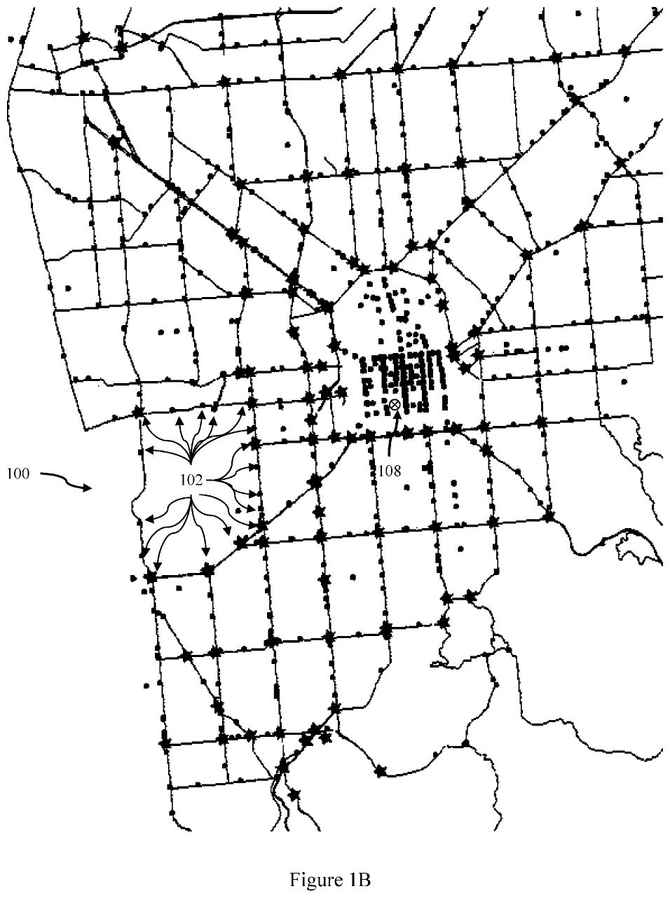

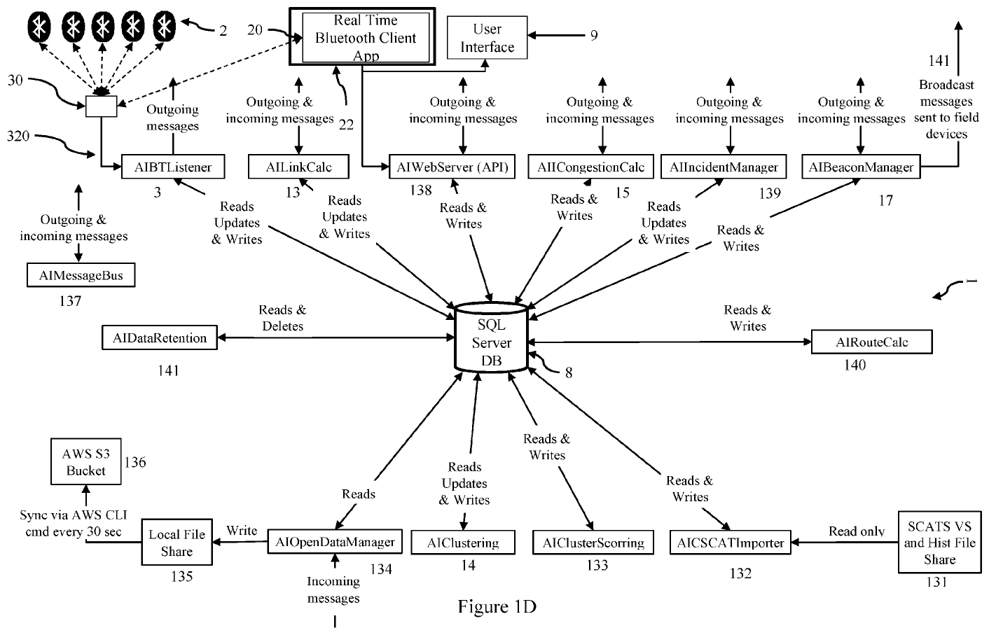

Referring now to FIG. 1A, there is shown a schematic drawing of a traffic monitoring system 1 according to an embodiment. The system comprises a plurality of plurality of traffic monitoring Bluetooth transceiver apparatus 30 each located at a fixed site location 102 in a road traffic network 100, a traffic network monitoring centre 10, and a plurality of traffic status listener apps 20 which in use are configured to execute on user devices 22. These user devices may be mobile phones, tablets, laptops, and portable computing devices including vehicle entertainment systems. FIG. 1B is a map of a road traffic network 100 showing major roads (minor roads and inner city roads have been omitted for clarity) and the locations 102 of traffic monitoring Bluetooth transceiver apparatus 30 (black dots) such as at traffic signals and pedestrian crossings, as well as the location 108 of a traffic network monitoring centre 10. In one embodiment traffic monitoring apparatus 30 are integrated into SCATS boxes located adjacent traffic signals or pedestrian crossings that provide power and a communications link back to the traffic network monitoring centre 10. The system may also comprise modular or stand-alone traffic monitoring Bluetooth transceiver apparatus 30 with a power supplies and a network interface providing a network connection (eg 3G/4G/Wi-Fi/Wired) back to the traffic network monitoring centre 10 independent of SCATS boxes.

Each traffic monitoring Bluetooth transceiver apparatus 30 is configured to store a site identifier (ID) 120 for its site location 102 and the traffic monitoring centre 10 stores the site identifiers and associated site locations 102 in a database 7. The site IDs 120 and associated site locations 102 are also stored locally in a message database by each traffic status listener app 20. The site IDs 120 is a unique device identifier within the system such a unique name (eg BT69; BT93) or MAC address of the Bluetooth transceiver apparatus (or based on a MAC address), intersection identifier, SCATS box identifier, a geographic location (lat, lon), or some other unique identifier.

The traffic monitoring Bluetooth transceiver apparatus 30 is also configured to detect Bluetooth transmissions of nearby Bluetooth enabled devices (field Bluetooth devices)—that is those within transmission range of the traffic monitoring Bluetooth transceiver apparatus 30. The transmission range is not an exact distance as it will depend upon factors such as transmitter power, receiver sensitivity and the local noise environment. For example this will include vehicles (cars, trucks, motor cycles, bicycles, etc) passing the Bluetooth transceiver apparatus 30 (ie going through the intersection) containing Bluetooth devices (eg mobile phones, hands free kits, incar entertainment systems etc), as well as Bluetooth devices carried by pedestrians (mobile phones, headsets, etc) and any local static Bluetooth devices. The traffic monitoring Bluetooth transceiver apparatus 30 extracts a Bluetooth address from each received transmission and records a timestamp for the transmission such as the day and time to the nearest second.

In some embodiments the traffic monitoring Bluetooth transceiver apparatus 30 enters a discovery mode for a discovery mode period to discover the MAC addresses of nearby Bluetooth devices. Only one record per MAC address is stored per discovery period, and as soon as a MAC address is found, the time stamp is recorded to the nearest second. In one embodiment a fifteen second discovery period was used as it provided a better indication of the arrival and departure times of each vehicle without creating an excessive number of records. As will be explained below, using Bluetooth discovery mode only detects or capture MAC addresses of around 15% of vehicles passing the traffic monitoring Bluetooth transceiver apparatus 30. As will be discussed below, in order to increase collection rates the traffic monitoring Bluetooth transceiver also configured to detect Bluetooth transmissions (ie outside of discovery mode) by nearby devices by detecting messages containing a part (but not the full) Bluetooth address. Using this approach data rates can be improved by 3-5 times, reaching capture rates of 50% or more.

Once a message is detected a unique device address, or part of an address is obtained, a capture message 320 sent to the traffic monitoring centre 10 comprising the site ID; a representation of the Bluetooth address, and the timestamp. The representation of the Bluetooth address may be the 48 bit MAC address, a portion of the MAC such as the Lower Address Part (LAP), or an anonymised MAC address. An anonymised MAC address may be obtained by taking a hash of the MAC address and sending the hash or a part of the hash (eg last N bits) as the representation of the Bluetooth address. In one embodiment the capture message 320 is a 22 byte message. In some embodiments the traffic monitoring Bluetooth transceiver apparatus 30 stores the address of any local static Bluetooth devices and any transmissions identified as being transmitted from these devices are ignored or discarded.

The traffic network monitoring centre 10 comprises a plurality of software services installed on servers, databases, software applications for planning and real time reporting of traffic status, and interfaces for communicating with the traffic monitoring Bluetooth transceiver apparatus 30 and the traffic status listener apps 20. The network monitoring centre may be a single site, or a distributed system implemented in several locations, including cloud based implementations. The system may be implemented in various operating systems or programming languages. FIG. 1A illustrates the various components of the traffic network monitoring centre 10.

The capture messages 320 are received from the plurality of traffic monitoring Bluetooth transceiver apparatus 30 via a network interface and processed by a live recording service 3 (for example a windows service application installed on a server). The live recording service 3 is configured to decode a received capture message, anonymise the representation of the Bluetooth address (eg the MAC address) if this was not already performed by the traffic monitoring Bluetooth transceiver apparatus. This is added to a real-time database 4 and paired with other records of same MAC address to get a device travel time through a link (or links) in the road traffic network.

The live processing service 5 processes or analyses the records in the real-time database 4 to generate site detection statistics, check the validity of new travel time records including removing outliers, and updates road segment aggregated travel times every 30 seconds. The live processing service may use other data such as SCATS lane count data or data from other sensors such as cameras feeds processed with automated license plate recognition software.

The live transfer service 6 moves data from temporary real-time database 4 to a primary database 8 (the Bluetooth and Detector Data Analysis Software or BADDASS database) and vice versa. A collection of data processing services process the data stored in the real-time database 4 and primary database 8 and a user interface 9 provides real-time congestion information to network operators and allows data to be interrogated for planning studies using the processed results. A monitoring service 7 monitors the status of the various services and restarts services as required (for example if they cease outputting data).

The collection of data processing services includes a SCATS VS Upload Service 11, SCATS History Upload Service 12, a Route Travel Time Calculation Service 13, a Link Travel Time Clustering Service 14, a Congestion Calculation Service 15, a Main Database Processing Service 16 and a Beacon service 17. The SCATS VS Upload Service 11 Reads SCATS “.VS” files (lane counts) and uploads data to database, the SCATS History Upload Service 12 reads SCATS “.hist files” (signal phase times) and uploads the data to database. Services can also be provided to load data from other sensor systems, such as automated licence plate recognition systems. The Main Database Processing Service 16 manages primary database tables and updates road segment aggregated travel times to create continuous 5-minute interval time series.

The Route Travel Time Calculation Service 13 joins live and historical travel time information for multiple road segments to predict route travel times and determines if route is operating worse than normal based on excess delay per kilometre.

The Link Travel Time Clustering Service 14 analyse up to 13 months of historic travel time data for each road segment to determine patterns (clusters). Each day can be divided into multiple periods and separately clustered. For example a day could be divided into 3 periods such as AM peak, PM peak and Business day, or clusters could be generated for each hour, half hour, or 10 or 15 minute period.

The Congestion Calculation Service 15 compares live travel times for each road segment against expected values from selected cluster time series and summarises key statistics for each road segment such as speed, delay, excess delay and congestion value. The service also determines if a road segment is operating worse than normal and generates network summary information for display on a reporting website.

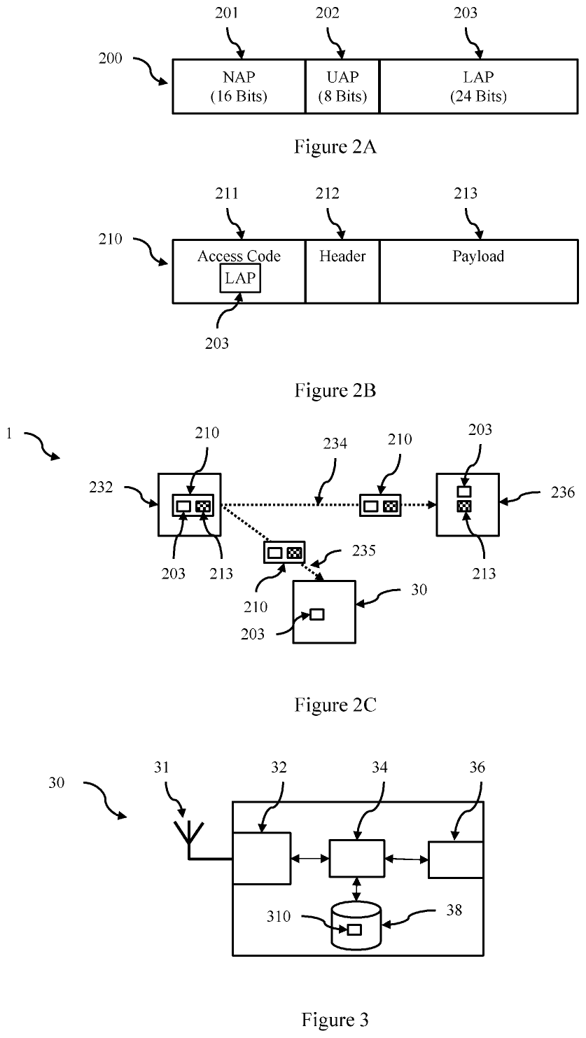

Beacon service 17 manages messages transmitted by traffic monitoring Bluetooth transceiver apparatus 30 to traffic status listener apps 20. In some embodiments a modified iBeacon format is used such as shown in FIG. 2A. The Beacon service 17 also identifies road segments that have abnormal congestion, activates traffic monitoring Bluetooth transceiver apparatus 30 to send traffic status messages 210 on the approaches to the congested road segments, and calculates the current total delay for each site approaching the congested segments.

The system 1 is configured to constantly monitor link travel times between adjacent traffic monitoring Bluetooth transceiver apparatus 30 and records the information as a continuous time series. The Clustering Service 15 runs daily to analyse the last 13 months of data to identify patterns in the time series data. The process automatically quarantines outliers such as excessive travel times caused by incidents. It automatically determines how many different clusters to create for each link depending on how much variation is present within the time series.

The clustering process compares the time series profile of road link (ie a road segment between two site locations (ie two traffic monitoring Bluetooth transceiver apparatus) for a target time period (for example AM peak on Mondays) against the same time period on other reference days. The other reference days may be just the same weekday (if sufficient data is available), or against every other week day, or even any other day. A similarity score or distance measure such as the Euclidean distance is calculated. A low Euclidean distance implies that the two days being compared are similar. Once this process is complete, the days with low Euclidean distance scores are placed next to each other and grouped into a dendrogram of hierarchical clusters. The dendrogram is a tree-like structure that connects all of the days together based on their Euclidean distance, which is the value of the y-axis. Applying a threshold Euclidean distance cutoff cuts the dendrogram into a set of clusters. One of the key benefits of cluster analysis is that it requires no manual intervention to remove outliers, providing a robust way to forecast travel times in a real time traffic monitor. For example if today were a Wednesday, it would be acceptable to use the travel times from the previous few Wednesdays as a way of forecasting the travel times for today. However, this is not always the best approach if one of the previous Wednesdays was in the school holidays or affected by an incident. The clustering process takes care of this automatically so that the forecast travel times are based on typical Wednesdays.

The Congestion Calculation service 15 determines which cluster to use for comparison against live travel time data. The selection process takes into consideration factors such as the current day of the week and school and public holidays to determine the most appropriate cluster for comparison.

The Congestion Calculation service 15 outputs two key statistics every 30 seconds for each road link—Excess Delay and Congestion. Excess Delay is the difference between the live travel time and the expected travel time—that is the road links experiencing delays greater than normal. The expected travel time varies across the day and takes into consideration recurrent delays to only highlight abnormal congestion. This is obtained by pre-running a cluster analysis for each road link across a 13-month period to identify typical travel time profiles based on these same factors. A cluster selection algorithm then compares the features of the current day against the features of the clusters to identify which cluster to use.

The Congestion parameter is based on Excess Delay, but magnifies delays on short or reliable road sections and shrinks delays on long or highly variable road sections. The Congestion parameter takes the Excess Delay value and converts it to the number of standard deviations (effectively the t-statistic=(observed variation)/standard deviation). The standard deviation for a link also varies across the day, just like the travel time. During the middle of the day, most links typically have a small standard deviation of travel time because the travel time tends to be fairly consistent. Road links containing level crossings tend to have larger standard deviations because the travel time is less reliable, in particular during the peaks. This means that a highly variable link such as this will need a larger Excess Delay than a more consistent link to achieve the same Congestion value.

Delay information based on the estimated Excess Delay and Congestion parameters is output to users on a map of the network via a website or the using traffic status listener apps. The map only shows abnormal congestion—recurrent congestion does not appear on the map (as the clustering will identify this as the normal travel time for that day and time), so commuters can quickly check if there is a problem on their route to/from work. FIG. 1C is a map of a portion of a road traffic network 100 indicating the locations and site IDs 120 of traffic monitoring Bluetooth transceiver apparatus 30, and road links showing excess congestion highlighted by colour coding according to an embodiment. As can be seen in this Figure there is congestion on link segment 111 between site IDs BT105 and BT 98, and congestion on adjacent link segment 112 between site IDs BT188 and BT 98. Heavy congestion is indicated on link 113 between site IDs BT3041 and BT69 by heavy black (originally orange) line. This congestion is reduced on link segment 114 between BT69 and BT93 shown in thin black (originally light yellow), and is back to normal range on link segment 115 between BT93 and BT374. No highlighting is performed for road links with travel times within normal or acceptable ranges (for that day and time).

The Route Calculation Service uses a combination of live and historic data to predict the travel time along any road corridor. This allows travel times to be predicted on signalised arterial roads, not just freeways. The information can be sent to roadside variable message signs (eg displays) units to provide guidance to commuters about comparative travel times to selected destinations.

The Beacon Service automatically configures traffic monitoring Bluetooth transceiver apparatus 30 to warn passing motorists of approaching congestion. The system identifies unusual congestion, determines which approach devices to activate and automatically transmits real time delay information. The traffic monitoring Bluetooth transceiver apparatus 30 broadcast messages which are received by user devices 22 executing the traffic status listener app 20. The traffic status listener app 20 processes the messages and can be used to display the message or speak the message to a user using a text to speech engine. The app also determines if the vehicle is approaching the congestion and if so converts the beacon message into a descriptive warning message that is spoken by the phone's text to speech engine. The app includes a local data base and does not require 3G or GPS to function, thus saving the phone battery. The traffic status message (Beacon) Service can also be used to automatically trigger warning messages on variable message signs and other roadside displays.

FIG. 1D shows schematic diagram of a system architecture according to another embodiment. In this embodiment a single data base 8 is used to store all data and the temporary real-time database 4 is eliminated or integrated into primary database 8, and the transfer service 6 is eliminated. A data retention service 141 monitors the database and removes duplicate records and other data as required. A message bus service 137 handles exchange of messages between the different services, an API based webserver 138 serves system data based on appropriate API requests. The API webserver also serves data to the user interface 9 and to client apps 22. An open data manager 134 also writes data from the database 8 to a local file share 135 which is synched with a cloud service 136. The data processing and calculation services are similar, with some services split and additional services added. The previous SCATS VS Upload Service 11, SCATS History Upload Service 12 are integrated into a single SCATS Importer service (or module) 132 which reads SCATS VS and Hist files from a filesharing site. As previously the data is clustered by clustering service 13 and a separate cluster scoring service 133 scores clusters for the current day and tomorrow. Link calculation service 13 determines the travel time of the links, and congestion service 14 determines congestion and excess travel times. An incident manager 139 detects incidents (eg excess delay or congestion) and in some embodiments identifies and merges related incidents. A route calculation service 140 calculates or stored predetermined routes between two or more devices. The Beacon manager 17 generates beacon messages which are send to the Bluetooth transceiver apparatus for broadcasting.

The performance, robustness and extent to which predictions can be used critically depends upon the amount of data that can be collected from vehicles moving through the road traffic network. As discussed above, the use of Bluetooth discovery mode by traffic monitoring Bluetooth transceiver apparatus 30 only captures 15% of vehicles passing devices, as only devices such as headsets and car audio systems are discoverable. Whilst smartphones can potentially be discovered, they are typically only in a discovery mode during a pairing process (ie when a user has actively gone to a settings page to pair with another device), and so in most cases are not discoverable in vehicles passing through an intersection, or are not repeatedly discoverable at two intersections defining a road link. This limits the accuracy of clustering, leading to increase variability in estimates of travel time, excess delay and congestion (which is based on standard deviation estimates).

One potential way to try and increase data rates would be to listen for smartphones looking for Wi-Fi access points, as there are typically a much large number of smartphones passing through an intersection compared to devices in Bluetooth discovery mode. Wi-Fi devices are configured to scan for an access point by transmitting a probe request frame containing the Wi-Fi MAC address of the transmitting device. Typically a device sends a probe request on a channel, briefly (eg 100 ms) listen for a probe response, and then moves to another channel, with this process being repeated for each of the 13 Wi-Fi channels. However whilst the amount of traffic is potentially much larger, one problem with smartphones is that the phone is able to decide when it will check for a new Wi-Fi access point, and in order to conserve battery life, most smartphones only perform a search for an access point once every 60 seconds That is a set of probe request frames are only transmitted once per minute, for around a second, and so the device will only be discoverable using Wi-Fi if it is within range for 60 seconds or more. Thus in a signalised road environment where there is relatively free flowing traffic, many devices will not be discoverable whilst they are in range of a detector. As such the effective Wi-Fi detection rates are about the same as Bluetooth discovery rates. Further, whilst a device may be detected at one intersection, given the long (60 second) undiscoverable period, the device may not be detected at the next intersection leading to a pairing rate (ie detection of the same device at two intersections) that is much lower than that for discoverable Bluetooth devices. Further, when in sleep mode, some devices (eg some apple iPhones), do not use their hardware MAC address to find access points, and instead use a random, often one-off, software generated MAC address. This prevents pairing of records between sites. Another problem is that Wi-Fi will detect smartphones on pedestrians, bikes and in buses, so in a busy city location these sources can generate significant additional noise that is not reflective of actual road traffic flows or congestion.

Thus to increase data rates, traffic monitoring Bluetooth transceiver apparatus 30 have been constructed which can detect and monitor active Bluetooth communications between paired devices. By detecting ongoing paired communications the data capture rates can be increased by 3-5 times—taking it from vehicle detection rates of 15% to 50% or more. This significantly improves the performance of the entire system, as there is more data to cluster, and estimation of mean and standard deviation for travel times, excess travel times and congestion are more reliable (a 4 times increase in data translates to a 2 fold reduction in the standard deviation). This allows reliable extension to low volume roads (eg country links), and in general the algorithms respond better and provide more robust and reliable results. Further, rather than only being able to detect classic Bluetooth devices, the Bluetooth transceiver apparatus 30 can detect Bluetooth low energy transmissions.

As shown in FIG. 2A, a Bluetooth Device Address (BD ADDR) 200 is a 48 bit Media Access Control (MAC) address comprised of a 16 bit Non-significant Address Part (NAP) 201, a 8 bit Upper Address Part (UAP) 202 which together uniquely identify the manufacturer, and a 24 bit Lower Address Part (LAP) 203 that is unique to a device from the manufacturer. The UAP is only transmitted during handshaking to establish a Bluetooth connection or during Bluetooth discovery. Once a Bluetooth connection is established between two devices, the full MAC address is dropped from packets. However, as shown in FIG. 2B, which is representation of a frame 210 of a Bluetooth message between paired devices, the LAP 203 of the transmitting device is included in the clear in every message. The message comprises an access code portion 211, a header portion 212 and the payload (data) portion 213.

FIG. 2C is a schematic diagram of a two paired Bluetooth devices 232 236 sharing a message 210 over a Bluetooth link 234. The transmitting device inserts their LAP 203 into the messages and sends the message to the paired device 236. The paired device receives and decodes the message extracting the LAP and message payload. In one embodiment a traffic monitoring Bluetooth transceiver apparatus 30 is configured to listen and detect (intercept) the transmitted message 210. The access portion of the message is decoded to capture the LAP 203 and the rest of the message is discarded. The traffic monitoring Bluetooth transceiver apparatus 30 records a time stamp of the day and time of the transmission, and this transmitted to the traffic monitoring centre 10 in a capture message comprising the site ID; a representation of the Bluetooth LAP address, and the timestamp. In one embodiment the traffic monitoring Bluetooth transceiver apparatus 30 stores the LAP with the time stamp, and only sends a capture message when the LAP is no longer detected within a predefined monitoring window (for example 1, 5 or 10 seconds). This ensures a capture message is only sent once the device is out of range of the traffic monitoring Bluetooth transceiver apparatus 30 or the link is shut down.

FIG. 3 is a schematic representation of a traffic monitoring Bluetooth transceiver apparatus 30 according to an embodiment. The traffic monitoring Bluetooth transceiver apparatus comprises an antenna 31, an RF transceiver module 32, one or more microprocessors 34, and a network interface 36 and a memory 38 which stores a unique device site identifier (ID) 310. The device site identifier may be a 16 byte universally unique identifier (UUID). The apparatus may include additional components, modules, boards and/or circuits, such as those providing, power supply, 3G/4G/5G modem, WiFi, Ethernet, USB, and HDMI connections. The apparatus may use a single microprocessor or comprise multiple microprocessors, such as task specific microprocessors (eg for implementing a Bluetooth stack and functionality) and a general purpose controller. The apparatus may be powered using a range of appropriate power circuits and interfaces, such as 120/240V mains, Power over Ethernet (PoE), Solar, and/or battery. A general purpose compute module, or system on a board may be used to coordinate and control operation of the apparatus 30, such as a Raspberry Pi Compute module.

Bluetooth radio communications operate in the 2.4 GHz band (2.4 GHz-2.5 GHz or ISM band) from 2.4 GHz to 2.485 GHz. The RF transceiver module 32 comprises a RF front end that receives an input signal and applies initial processing such as applying a 2.4 GHZ bandpass filter and low noise amplification before down converting to an intermediate frequency for digitisation and further processing. The initially processed signal is then either directly sampled (ie in a software defined radio) or down converted and sampled to generate a digital signal which then undergoes base band processing (eg demodulation, error correction and decoding) to perform packet recovery.

The microprocessor (s) 34, which may be a microcontroller or system on a chip, is configured to detect at least the Lower Address Part (LAP) of a Bluetooth Device Address in a received transmission, and may be further configured to implement a full Bluetooth Stack. This may comprise directly recovering and decoding Bluetooth packets from a captured spectrum signal, and then extracting the LAP from the recovered packet, or the RF front end, or RF transceiver may recover and decode Bluetooth packets and provide the packet to the microprocessor for identification of the LAP within a recovered packet (eg based on known packet format). For example the RF front end may capture and demodulate signals in the 2.4 GHz band with a bandwidth of 1 MHz, using a modulation scheme such as Frequency Shift Keying to enable detection/recognition of Bluetooth packets according to formats defined in the Bluetooth stack. In one embodiment the RF front end is a Texas Instruments CC2591 2.4 GHz RF Front End LNA+PA QFN-16 package, the RF transceiver module 32 is a single-chip 2.4 GHz RF transceiver such as the Texas Instruments CC2400, and the microprocessor is a NXP LPC175 ARM Cortex-M3 microcontroller or similar. In one embodiment a Bluetooth transceiver chip such as a Cypress Semiconductor Bluetooth Smart (BLE) Module CY8CKIT-141 is used which provides the front end and microprocessor (for processing the spectrum signal and extracting the LAP) on a single board.

The network interface 36 is configured to send a plurality of capture messages, each message comprising a representation of a received LAP 203, a time stamp, and a device site identifier (ID) 310 (eg the UUID). The memory 310 is used to store instructions to configure the operation of the microprocessor and to store the device site identifier (ID). The memory may also stores the received LAP and time stamp, either on a temporary basis until a capture message is sent, or over long time frames, for example to maintain a historical record of detected devices. The representation of the LAP 203 may be the LAP itself, a unique identifier for the LAP, or a hash of the LAP (or n-bit portion of the hash) may be sent to anonymise the LAP. The network interface may be implemented as separate communications module, supporting wired or wireless communications protocols, or it may be part of a general purpose microprocessor module or system on a chip, such as a Raspberry Pi 3 Model B system board or a Raspberry Pi Compute module integrated onto a custom board.

In one embodiment the microprocessor in the general purpose microprocessor module is used to receive the Bluetooth addresses from the microprocessor that processes the received RF packets, and performs more general tasks such as collation, generation and transmission of capture messages. This can assist in load balancing by allowing one processor to focus on processing received transmissions, and another processor to coordinate operation of the device and sending of capture messages back to the network centre. However a single microprocessor may be used if it has sufficient computational power to handle all required task (eg processing of received RF transmission and generation of capture messages). Additional boards and components may be used to provide power, or provide WiFi or 3G/4G data connectivity. In one embodiment a Wi-Fi Board comprises a Redpine Signals RS9113-NBO-DON 802.11a/b/g/n Wi-Fi and Bluetooth module for detecting Wi-Fi packets, and optionally for implementing the Bluetooth Stack for Bluetooth transmissions (eg broadcasting of iBeacons), or processing of Bluetooth packets. In one embodiment a 3G modem board comprises a HL8548-G AirPrime HL Series 3G modern with GNSS module, with a ATTINY84A-SSU 8 bit microcontroller for controlling the board and interfacing with the general purpose microprocessor, and which are connected to connectors for a GPS antenna and a 3G antenna located on a housing for the apparatus. In one embodiment A power over Ethernet board, provides power and Ethernet and 10/100 Ethernet connectivity using a Microchip/SMSC LAN9514 USB 2.0 Hub (4×) and 10/100 Ethernet Controller chip with a LINK-PP RJ45-TFR-POE LAN Transformer WE-RJ45LAN 10/100 Ethernet PoE and a Diodes Inc AP2176MPG Dual USB 2.0 Power Switch, 1500 mA max, 1A cont. The various components may located on a single board or comprise multiple connected boards, and may be located in a compact DIN rail mountable housing providing USB, Ethernet and antenna connections.

The traffic monitoring Bluetooth transceiver apparatus passively and anonymously listens for the Bluetooth communications between paired devices in vehicles as they pass the transceiver. For example these may be Bluetooth communication links between a mobile phone and hands free kit, a car communication consoles, or a headset. The receiver does not attempt to fully decode a received Bluetooth packet, or uniquely identify the Bluetooth device (ie determine the full Bluetooth Address) and instead monitors the existence of an active Bluetooth connection between devices associated with a vehicle or passenger in a vehicle.

In one embodiment, every time the traffic monitoring Bluetooth transceiver apparatus detects a Bluetooth message, it extracts the LAP and sends a message to a traffic (or network) operations centre 10 comprising a representation of a received LAP, a time stamp, and a receiving apparatus site identifier (ID). Alternatively once a new LAP is detected, the traffic monitoring Bluetooth transceiver apparatus may monitor further transmissions for transmissions including the received LAP. When no transmissions including the received LAP have been received within a predetermined time out window, the capture message is sent. The predetermined time out window may be 1, 5, 10, 20, 30, or 60 seconds or more, This approach thus only sends the capture message when a Bluetooth Device have moved out of communications range. The time stamp may correspond to the time of first detection, or time of last detection.

In one embodiment traffic monitoring Bluetooth transceiver apparatus stores LAP of nearby devices. A new LAP is identified if the detected LAP has not been detected within a previous time out window. This time out window is long enough to ensure that it is a new detection corresponding to a new journey by the vehicle, and not a vehicle moving slowly past the apparatus. In most cases this time-out window will be of the order of minutes to tens of minutes. It can be varied based on time of day, by past history, or at a system level by a message from the traffic operations centre. For example traffic monitoring Bluetooth transceiver apparatus 30 or traffic network monitoring centre 10 could determine the average time a vehicle is within range of the receiver apparatus, along with the standard deviation, and set the time out window to the mean plus 3 standard deviations. Robust estimates could also be used (eg median and Inter Quartile Range), or by ranking the observed durations and setting the time out period as the 99.9% quartile.

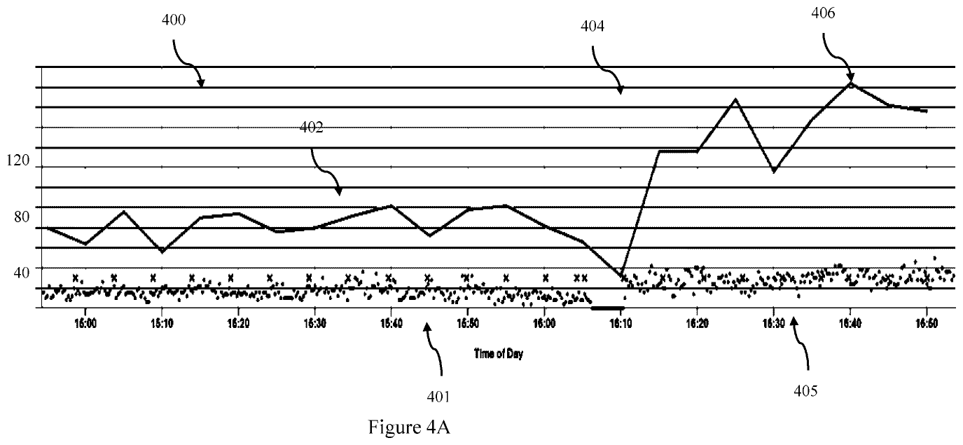

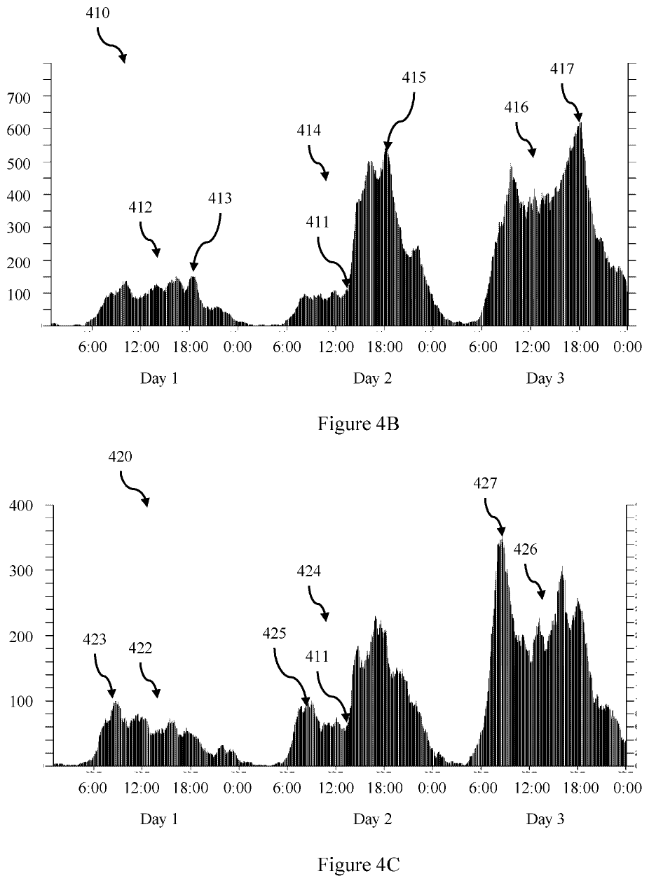

FIG. 4A is a plot 400 of the number of unique Bluetooth devices discovers as a function of time spanning the point in time 404 when LAP packet detection is switched on. The blue line is the unique device count over a 5 minute period, obtained by averaging 15 second raw device count data. Prior to switching on LAP packet detection (time 404), the raw device counts 401 are just under 10, and the 5 minute average 402 is 40±10. After LAP packet detection is switched on (time point 404) the raw device counts 405 increase to around 15, and the 5 minute average 406 is 90±20. FIGS. 4B and 4C show histograms of the change in the pairing rate between two adjacent device (ie a road segment) as a function of time over three days spanning switching on LAP packet detection in both devices for the two opposite travel directions along the segment. FIG. 4B shows histograms 410 of the pairing count rate for a first direction of travel between two devices. The day 1 histogram 412 has pairing count rates of between 100 and 150 during the day reaching a peak of around 150 at 6 pm 413. During Day 2, histogram 414 has a similar shape to day 1 until the LAP packet detection is turned on around 2 pm (time point 411) after which the pairing rate soars. By the evening 6 pm peak the detection rate was around 550. The Day 3 histogram 416 shows elevated detection rates between 350 and 550 reaching a peak of around 625 at 6 pm 417. This represents around a 3.7 times increase in pairing rates. FIG. 4B shows histograms 420 of the pairing count rate for a second direction of travel between two devices (opposite direction to FIG. 4A). The day 1 histogram 422 has pairing count rates of between 60 and 80 during the day with the morning peak reaching around 100 at around 9 am 423. During Day 2, histogram 424 has a similar shape to day 1 with a morning 9 am peak of around 100 and values around 60-100 until the LAP packet detection is turned on around 2 pm (time point 411) after which the pairing rate soars. By the evening 6 pm peak the detection rate was around 240. The Day 3 histogram 426 shows elevated detection rates between 160 to 340 with the morning peak reaching a peak of around 350 at around 9 am 427. This represents around a 3.5 times increase in pairing rate. The two test sites used for this pairing comparison initially picked up around 8000 unique Bluetooth devices per day. Once the LAP packet detection was turned on this jumped to around 35,000 unique Bluetooth devices per day—a 4.4 times increase.

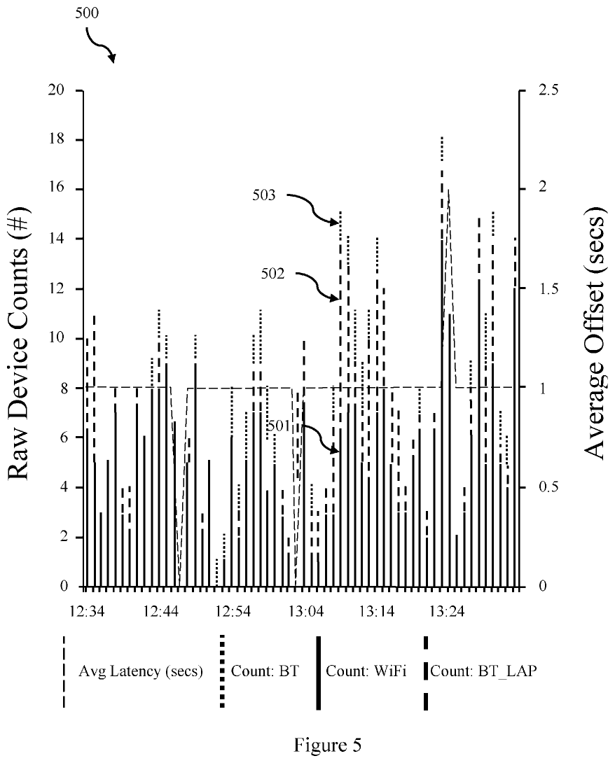

In another embodiment the above transceiver apparatus 30 further includes a Wi-Fi module, which constantly scans the 13 Wi-Fi channels to detect devices (eg smart phones) scanning for access points by transmitting probe request. In another embodiment the device includes two Wi-Fi modules, each configured to scan a distinct subset of Wi-Fi channels eg first module scans channels 1-6 and the second module scans channels 7-13. Adding a Wi-Fi module to a Bluetooth LAP packet detector can increase device collection by an additional 10-20%. Further such an apparatus can be used to detect pedestrians, as many pedestrians carry smartphones and are likely to be within range of a sensor for more than 60 seconds. Such an apparatus can be implemented by splitting the antenna output, or RF front end output, and feeding the input signal to a Wi-Fi decoder module which is configured to identify probe requests and extract the Wi-Fi MAC address of the transmitting device. FIG. 5 shows a plot of the raw device counts for such a device. Each bar is formed of the sum of Wi-Fi counts—bottom section of bar in solid black line (originally pink) 501, Bluetooth LAP packet counts—middle section of bar in dashed lines (originally black) 502, and classic Bluetooth discovery counts—top section of bar in dotted line (originally brown) 503. For example in the bar shown, the Wi-Fi counts 501 are 6 devices, the Bluetooth LAP counts 502 are 8 devices and classic Bluetooth discovery counts 503 is 1, giving a total of 15 devices.

In another embodiment the transceiver apparatus 30 could be further extended to detect other broadcast identifiers used in other RF protocols operating in the 2.4 GHz band. For example the antenna output, or RF front end output could be provided to a decoder module for another RF protocol (eg ZigBee or IEEE 802.15) which uses a clear unique device address in messages. Such an apparatus can be implemented in a software defined radio which receives the output of either the antenna or RF front end and performs multiple processing of the received signals—for example Bluetooth LAP detection, classic Bluetooth discovery, Bluetooth Low Energy (BLE) discovery, a Wi-Fi other RF protocols. Similarly a more hardware orientated apparatus could be used in which the output of the antenna or RF front end is provided to separate radio communications modules, each configured to detect a different RF protocol, for example to a Bluetooth LAP detection module, classic Bluetooth discovery module, a Bluetooth Low Energy (BLE) module, a Wi-Fi module and other decoder modules implementing RF protocols (or stacks). Some combination of the two could also be used. For example an apparatus with separate Wi-Fi and Bluetooth modules where the Bluetooth module could be configured to LAP in paired transmissions as well as classic and BLE devices in discovery mode.

In one embodiment a locality (or implementation) identifier (ID) is a 16 byte universally unique identifier (UUID) which is stored by transceiver apparatus 30 and identifies which traffic network the apparatus is part of. For example each state, city or region will have a different UUID, so the user app can determine which traffic network it is within and receiving data from. The transceiver apparatus 30 further stores a locally unique site ID which identifies the location of the transceiver apparatus 30 within the current traffic network. That is, in some embodiments, the site ID may not be globally unique but is unique to the current traffic network, or at least unique to the current traffic network and any adjacent networks. Site IDs could be unique to a country or continent. This allows site IDs to be reused between non adjacent road traffic networks or implementations, and reduces the number of bits required to store the site ID. For example 12 bit site ID can be used to identify 4095 sites. Transmissions can include the UUID of the locality and the site ID allowing a user app to determine the site location and appropriate database or mapping files for looking up or decoding coded data contained in a message. If a user app detects a change of UUID, this indicates the vehicle is now in a new traffic network, and the app is triggered to use the mapping database or files specific to the new location when looking up site IDs, and other network specific parameters. In an alternatively embodiment location services could be used to obtain the phone's current location to determine which traffic network it is within, however this incurs significant power costs, and is unreliable in the case of overlapping networks in built up areas.

As outlined above traffic monitoring Bluetooth transceiver apparatus 30 is also configured to broadcast messages which are received by user devices 22 executing the traffic status listener app 20. The traffic status listener app 20 processes the messages and can be used to display the message or speak the message to a user using a text to speech engine. In one embodiment the traffic monitoring Bluetooth transceiver apparatus 30 uses a modified iBeacon protocol to transmit broadcast messages. Beacon messages are sent to the Bluetooth transceiver apparatus for broadcasting.

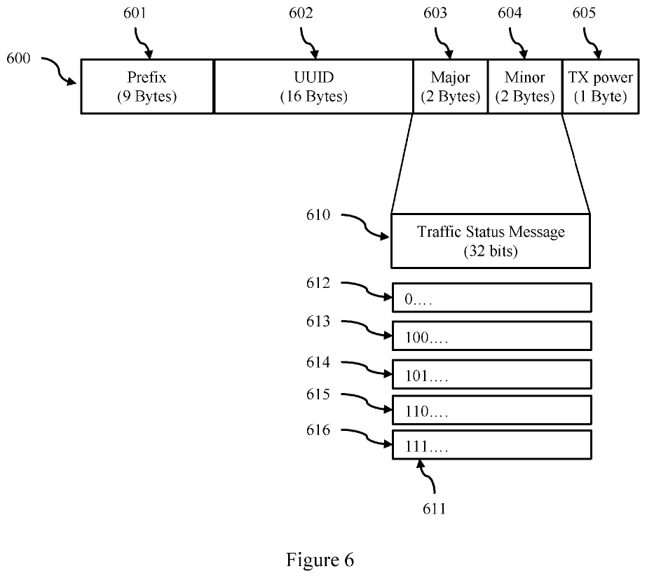

FIG. 6A is a schematic diagram of a modified iBeacon message frame 600 used by traffic monitoring Bluetooth transceiver apparatus 30 according to an embodiment. The iBeacon message format comprises a 9 byte prefix 601, a 16 byte universally unique identifier (UUID) field of the locality of the beacon transmitter, a 2 byte major field 603, a 2 byte minor field 604 and 1 byte transmit (TX) power field 605. In traditional iBeacon usage the beacon is fixed and generates a static beacon message where the major field is usually used to identify a subset of beacons within a large group, for example all iBeacons at a particular shop (Woolworths), and the minor number identifying a specific region within that particular shop (eg deli section).

As shown in FIG. 6A, in the modified iBeacon format used by the traffic monitoring Bluetooth transceiver apparatus 30, the Major and Minor fields are redefined as a single 32 bit traffic status message field 610 to define a broadcast beacon message with a dynamic format. The traffic status message field comprises a traffic status message field identifier 611 that defines the type of the traffic status message (612 613 614 615 616) each of which has a different format. The fields of each of the traffic status messages comprises message status codes with each code having an associated value such as an alphanumeric message string, a numeric value, or a parameter value. In some message formats, the site ID of the site broadcasting the iBeacon is included in the traffic status message. The traffic status listener apps comprises a message database that comprises the set of traffic status message field identifiers and associated message formats, as well as the mappings of the message status codes to the values. These formats and mappings are stored in a mapping database in the traffic status listener apps to enable them determine the type of the traffic status message and to decode a received traffic status message. In some embodiments these mappings are locality specific, and thus the UUID is used to determine the appropriate database or records to use when mapping a code to a value.

The traffic monitoring centre 10 selects type of traffic status message 210 from the set of traffic status messages known to the system to send to one or more traffic monitoring Bluetooth transceiver apparatus 30. The message is formatted with the relevant message status codes to encode information associated with the type of traffic status message to be sent, and this is sent to one or more traffic monitoring Bluetooth transceiver apparatus 30. Each traffic monitoring Bluetooth transceiver apparatus 30 that receives the traffic status message constructs a modified iBeacon message in which the UUID field 202 is the locality (or encodes the locality in a known way) of the traffic monitoring Bluetooth transceiver apparatus 30, and the major and minor field are replaced with the traffic status message 210, and this modified Beacon message is broadcast (transmitted) 221 to any listening Bluetooth devices. The traffic status message may include the (locally unique) site ID of the Bluetooth transceiver apparatus 30.

In one embodiment the traffic status messages comprises an incident delay message 212 in which the traffic status message field identifier 211 is 0 in bit 31; a multiple incident delay message 213 in which the traffic status message field identifier 211 is a 1 in bit 31, a 0 in bits 30 and 29; an information message 214 in which the traffic status message field identifier 211 is a 1 in bit 31, a 0 in bit 30 and a 1 in bit 29; a travel time message 215 in which the traffic status message field identifier 211 is a 1 in bit 31, a 1 in bit 30 and a 0 in bit 29; and a special beacon message 216 in which the traffic status message field identifier 211 is a 1 in bit 31, a 1 in bit 30 and a 1 in bit 29.

Each traffic monitoring Bluetooth transceiver apparatus 30 can only broadcast one message at a time. Messages can be assigned priorities to allow a traffic monitoring Bluetooth transceiver apparatus to determine what message to broadcast. By default incident messages (eg 212 213) are most important and will override a general information message (214) in the case of an incident. If messages have the same priority, the incident message will be broadcast, but the message will flag that a second message is available for download. Travel Time broadcast messages (215) have the lowest default broadcast priority and will be overridden generally by information (214) and incident messages (212, 213). A traffic monitoring Bluetooth transceiver apparatus 30 could broadcast several messages according to a schedule. For example they could broadcast travel time message and periodically transmit a general information message. An incident message will override schedules messages. Messages could be given an expiry time, after which the message may not be transmitted and may be deleted or overwritten.

The present application describes a traffic monitoring system that can be used in arterial road traffic networks found in cities. Traffic monitoring Bluetooth transceiver apparatus 30 are located at intersections and other points in the network. These detect Bluetooth transmissions of Bluetooth devices in passing vehicles which is passed back to a traffic monitoring centre which uses a clustering approach to build up travel time profiles and variances for each link in the system as a function of day and time. This allows excess delay and a congestion parameter to be estimated for each link which can then be used to identify incidents, and to a generate a range of traffic status messages which can be broadcast by the Traffic monitoring Bluetooth transceiver apparatus. The system analyses the travel paths of vehicles approaching an incident and determines the incoming routes to the incident and generates alert message for Traffic monitoring Bluetooth transceiver apparatus (beacons) along the route which broadcast the alerts.

Thus to increase data rates, the traffic monitoring Bluetooth transceiver apparatus 30 have been constructed to detect and monitor any active Bluetooth communications between paired devices. By sniffing the LAP included in ongoing paired communications the data capture rates can be increased by 3-5 times—improving the vehicle detection rate from around 15% using Bluetooth device discovery to 50% or more. This significant improves the performance of the entire system, as there is more data to cluster, and estimation of mean and standard deviation for travel times, excess travel times and congestion are more reliable (a 4 times increase in data translate to a 2 fold reduction in the standard deviation). This allows reliable extension to low volume roads (eg country links), and in general the algorithms respond better and provide more robust and reliable results.

Various aspects of the system are computer implemented on computing devices comprising a processor (eg CPU) and a memory and in some cases an input device and a display device. The memory may comprise instructions to cause the processor to execute a method described herein. The computing device may be a desktop computer, a portable computing device such as a laptop computer or tablet, smartphone, a server, including a cloud based service, or they may be included in a customised device. The computing devices may be unitary computing or programmable devices, or a distributed device comprising several components operatively (or functionally) connected via wired or wireless connections, including cloud based devices. The CPU may comprises an Input/Output Interface, an Arithmetic and Logic Unit (ALU) and a Control Unit and Program Counter element which is in communication with input and output devices (eg input device and display apparatus) through the Input/Output Interface. The Input/Output Interface may comprise a network interface and/or communications module for communicating with an equivalent communications module in another device using a predefined communications protocol (e.g. Bluetooth, Zigbee, IEEE 802.15, IEEE 802.11, TCP/IP, UDP, etc). A graphical processing unit (GPU) may also be included. The display apparatus may comprise a flat screen display (eg LCD, LED, plasma, touch screen, etc), a projector, CRT, etc. The computing device may comprise a single CPU (core) or multiple CPU's (multiple core), or multiple processors. The computing device may use a parallel processor, a vector processor, or be a distributed computing device. The memory is operatively coupled to the processor(s) and may comprise RAM and ROM components, and may be provided within or external to the device. The memory may be used to store the operating system and additional software modules or instructions. The processor(s) may be configured to load and executed the software modules or instructions stored in the memory.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software or instructions, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. Software modules, also known as computer programs, computer codes, or instructions, may contain a number a number of source code or object code segments or instructions, and may reside in any computer readable medium such as a RAM memory, flash memory, ROM memory, EPROM memory, registers, hard disk, a removable disk, a CD-ROM, a DVD-ROM, a Blu-ray disc, or any other form of computer readable medium. In some aspects the computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media. In another aspect, the computer readable medium may be integral to the processor. The processor and the computer readable medium may reside in an ASIC or related device. The software codes may be stored in a memory unit and the processor may be configured to execute them. The memory unit may be implemented within the processor or external to the processor, in which case it can be communicatively coupled to the processor via various means as is known in the art.

Further, it should be appreciated that modules and/or other appropriate means for performing the methods and techniques described herein can be downloaded and/or otherwise obtained by computing device. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a computing device can obtain the various methods upon coupling or providing the storage means to the device. Moreover, any other suitable technique for providing the methods and techniques described herein to a device can be utilized.

In one form the invention may comprise a computer program product for performing the method or operations presented herein. For example, such a computer program product may comprise a computer (or processor) readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

Please note that the following claims are provisional claims only, and are provided as examples of possible claims and are not intended to limit the scope of what may be claimed in any future patent applications based on the present application. Integers may be added to or omitted from the example claims at a later date so as to further define or re-define the scope.

1. A traffic monitoring Bluetooth transceiver apparatus comprising:
at least one antenna;
an RF transceiver module configured to operate in a least the 2.4 GHz Band;
at least one microprocessor configured to detect at least the Lower Address Part (LAP) of a Bluetooth Device Address in a received transmission; and
a network interface configured to send a plurality of capture messages, each capture message comprising a representation of a received LAP, a time stamp, and a device site identifier (ID).

2. The traffic monitoring receiver apparatus as claimed in claim I, wherein the microprocessor is configured to monitor further transmissions for transmissions including the received LAP, and when no transmissions including the received LAP have been received within a predetermined time out window, the capture message is sent.

3. The traffic monitoring receiver apparatus as claimed in claim 1, wherein the at least one microprocessor is further configured to detect a Wi-Fi probe request, and extract a Wi-Fi device MAC address from the probe request, and the network interface is configured to send a capture message comprising the received Wi-Fi device MAC, a time stamp and the device site ID.

4. A traffic monitoring system comprising:
a plurality of traffic monitoring Bluetooth transceiver apparatus each comprising:
at least one antenna;
a radio frequency (RF) transceiver module configured to operate in a least the 2.4 GHz Band;
at least one microprocessor configured to implement a Bluetooth Stack and to detect at least the Lower Address Part (LAP) of a Bluetooth Device Address in a received transmission; and
a network interface configured to send a plurality of capture messages, each capture message comprising a representation of a received LAP, a time stamp, and a device site identifier (ID); and
a traffic network monitoring centre, wherein
each traffic monitoring Bluetooth transceiver apparatus is located at a fixed site location in a traffic network and the device site ID is associated with the site location;
the traffic network monitoring centre is configured to receive and process the capture messages to determine link travel times for a link defined by two traffic monitoring Bluetooth transceiver apparatus, and obtain an estimate of an excess delay and a congestion for each link.

5. The traffic monitoring system as claimed in claim 4, wherein the at least one microprocessor is further configured to detect a Wi-Fi probe request, and extract a Wi-Fi device MAC address from the probe request, and the network interface is configured to send a capture message comprising the received Wi-Fi device MAC, a time stamp and the device site ID.

6. A method for monitoring traffic comprising:
receiving, by a receiver located at a fixed site location in a road traffic network, one or more radio frequency transmissions;
detecting at least the Lower Address Part (LAP) of a Bluetooth Device Address in one or more received transmissions;
transmitting a capture message comprising a representation of a received LAP, a time stamp, and a device site identifier (ID) of the receiver to a monitoring centre;
receiving a plurality of capture messages from a plurality of receivers at a plurality of fixed site locations and identifying a LAP received at two of the plurality of fixed site locations to determine a link travel time for a link defined by the two fixed site locations, and obtaining an estimate of an excess delay and a congestion for each link.

7. The method as claimed in claim 6, wherein the detecting step further comprises:
detecting at least the Lower Address Part (LAP) of a Bluetooth Device Address in a received transmission;
monitoring further transmissions for transmissions including the received LAP, and when no further transmissions including the received LAP have been received within a predetermined time out window, transmitting the capture message comprising a representation of the received LAP.

8. The method as claimed in claim 6, wherein the detecting step further comprises:
detecting a Wi-Fi probe request,
extracting a Wi-Fi device MAC address from the probe request; and
transmitting a capture message comprising a representation of a received Wi-Fi device MAC address, a time stamp, and a device site identifier (ID) of the receiver to a monitoring centre.

9. The traffic monitoring receiver apparatus as claimed in claim 2, wherein the at least one microprocessor is further configured to detect a Wi-Fi probe request, and extract a Wi-Fi device MAC address from the probe request, and the network interface is configured to send a capture message comprising the received Wi-Fi device MAC, a time stamp and the device site ID.

10. The method as claimed in claim 7, wherein the detecting step further comprises:
detecting a Wi-Fi probe request,
extracting a Wi-Fi device MAC address from the probe request; and
transmitting a capture message comprising a representation of a received Wi-Fi device MAC address, a time stamp, and a device site identifier (ID) of the receiver to a monitoring centre.
